(19) United States
(12) Patent Application Publication
(10) Pub. No.: US 2009/0054571 A1
(43) Pub. Date: Feb. 26, 2009

(54) FINISHING PRODUCT BOOSTER ADDITIVE AND METHOD OF USING SAME

(75) Inventors: David Ostroff, Cardiff, CA (US); David Bynon, Coronado, CA (US); Rick L. Vaal, Sarcasota, FL (US); Sam Lankford, Bradenton, FL (US)

Correspondence Address: DUCKOR SPRADLING METZGER & WYNNE;A LAW CORPORATION, 3043 4th Ave., SAN DIEGO, CA, 92103, US

(73) Assignee: Premium Finish Care, LLC

(21) Appl. No.: 11/845,001

(22) Filed: Aug. 24, 2007

(51) Int. Cl. C08K 5/09

(52) U.S. Cl. 524/262

(57) ABSTRACT

A finishing product booster additive and a method of using it to improve the performance and durability of the finishing product according to certain embodiments of the invention may include amino functional siloxanes. According to certain embodiments of the invention, the finishing product booster additive may contain additional finishing product additive materials, such as volatile cyclic siloxanes, drying agents, organic solvent carriers, water, non-ionic surfactants, dyes, and fragrances in addition to the amino functional siloxanes.

### FIELD OF THE INVENTION

The present invention relates in general to a finishing product booster additive and a method of using it. It more particularly relates to an amino functional siloxane based finishing product booster additive and a method of using it to improve the performance and durability of the finishing product.

### BACKGROUND ART

This section describes the background of the disclosed embodiment of the present invention. There is no intention, either express or implied, that the background art discussed in this section legally constitutes prior art.

Commercial finishing products, such as waxes, polishes, and sealants are commonly used for protecting and enhancing the appearance of the surface of various objects, such as automobiles, furniture, counter tops, and other objects comprised of natural stone, stainless steel, glass, plastic, rubber, metal, paint, fiberglass, polymethyl methacrylate (such as Plexiglas®), polycarbonate (such as LEXAN®), fabric, aluminum, vinyl, or leather.

Although there are several commercial finishing products available, consumers are always looking for new and improved methods for enhancing the protection and appearance of their surfaces.

### DESCRIPTION OF CERTAIN EMBODIMENTS OF THE INVENTION

As a preface to the detailed description, it should be noted that, as used in this specification and the appended claims, the singular forms “a”, “an”, and “the” include plural referents, unless the context clearly dictates otherwise.

When the term “about” is used herein, it is for purposes of indicating that the precision of the nominal value presented is ±10%.

It will be readily understood that the components of the embodiments as generally described herein, could be arranged and designed in a wide variety of different configurations. Thus, the following more detailed description of the embodiments of the additive and method of the present invention is not intended to limit the scope of the invention, as claimed, but is merely representative of the embodiments of the invention.

A finishing product booster additive and a method of using it to improve the performance and durability of the finishing product according to certain embodiments of the invention may include an amino functional siloxane. According to certain embodiments of the invention, the finishing product booster additive may contain additional finishing product additive materials, such as volatile cyclic siloxanes, drying agents, organic solvent carriers, water, non-ionic surfactants, dyes, and fragrances in addition to the amino functional siloxane.

Addition of the finishing product booster of the present invention to a finishing product prior to application of the finishing product to a surface may result in an improvement in the protection and durability offered by the finishing product on the surface, enhanced slickness and shine of the surface, and reduced dust and dirt build up on the surface between cleanings. The finishing product plus finishing product booster additive will create a coating on the applied surface that may be extremely tolerant to heat and chemicals.

The finishing product plus finishing product booster additive may be used on a wide variety of surfaces, including, but not limited to, porous surfaces, non-porous surfaces, flexible surfaces, and non-flexible surfaces.

According to certain embodiments of the invention a method for boosting the performance of a finishing product for application to a surface, comprising: adding to the finishing product at the time of application, a composition that may include an amino functional siloxane.

The amino functional siloxane may be comprised of amino-alkoxy dimethylsiloxane, aminoalkoxydimethylpolysiloxane, a combination thereof, or others.

In certain embodiments of the method, the composition may include from about 4% by weight to about 100% by weight of amino functional siloxane. In other embodiments, the composition may include from about 4% by weight to about 20% by weight of amino functional siloxane. In another embodiment, the composition may include from about 4.5% by weight to about 8.5% by weight of amino functional siloxane. In further embodiments, the composition may include from about 40% by weight to about 100% by weight of amino functional siloxane. In yet another embodiment, the composition may include from about 50% by weight to about 85% by weight of amino functional siloxane.

According to another embodiment of the method, the composition may further include about 0% by weight to about 20% by weight of a non-ionic surfactant and a balance that may be selected from the group consisting of water, organic solvent carrier, or a combination thereof.

The non-ionic surfactant may be comprised of alkoxy polyethoxy ethanol, diethanolamine, coconut oil diethanolamide, acrylic polymer, nonylphenol ethoxylate, oleamide DEA, oleic acid, a combination thereof, or others.

The organic solvent carrier may be comprised of petroleum distillate, Stoddard solvent, synthetic isoparafinic hydrocarbon, petroleum hydrocarbon, aliphatic hydrocarbon, 2,2-dimethylbutane, a combination thereof, or others.

In certain embodiments, the composition may include about 1% by weight to about 20% by weight of a non-ionic surfactant and a balance selected from the group consisting of water, organic solvent carrier, or a combination thereof. In other embodiments, the composition may include about 10% by weight to about 15% by weight of a non-ionic surfactant and a balance selected from the group consisting of water, organic solvent carrier, or a combination thereof. In further embodiments, the composition includes about 0% by weight of a non-ionic surfactant and a balance of organic solvent carrier.

According to yet another embodiment of the method, the composition may further include about 0% by weight to about 50% by weight of a drying agent.

The drying agent may be comprised of isopropyl alcohol, methyl alcohol, 1,2,4-trimethylbenzene, a combination thereof, or others.

In certain embodiments, the composition may include about 0% by weight to about 15% by weight of a drying agent. In other embodiments, the composition may include about 1.5% by weight to about 6% by weight of a drying agent. In yet another embodiment, the composition may include about 9% by weight to about 28% by weight of a drying agent.

In further embodiments of the method, the composition may also include about 0% by weight to about 5% by weight of a volatile cyclic siloxane.

The volatile cyclic siloxane may be comprised of dimethylcyclosiloxane, hexamethylcyclotrisiloxane, octamethylcyclotetrasiloxane, decamethylcyclopentasiloxane, dodecamethylcyclohexasiloxane, a combination thereof, or others.

In certain embodiments, the composition may include about 0.5% by weight to about 5% by weight of a volatile cyclic siloxane.

According to yet another embodiment of the method, the composition further includes about 0% by weight to about 5% by weight of fragrance, and may include about 0% by weight to about 5% by weight of dye.

According to one embodiment of the inventive method, the composition may include:
about 4% by weight to about 100% by weight of an amino functional siloxane, wherein the amino functional siloxane may be comprised of amino-alkoxy dimethylsiloxane, aminoalkoxydimethylpolysiloxane, a combination thereof, or others;
about 0% by weight to about 5% by weight of a volatile cyclic siloxane, wherein the volatile cyclic siloxane may be comprised of dimethylcyclosiloxane, hexamethylcyclotrisiloxane, octamethylcyclotetrasiloxane, decamethylcyclopentasiloxane, dodecamethylcyclohexasiloxane, a combination thereof, or others;
about 0% by weight to about 50% by weight of a drying agent, wherein the drying agent may be comprised of isopropyl alcohol, methyl alcohol, 1,2,4-trimethylbenzene, a combination thereof, or others;
about 0% by weight to about 20% by weight of a non-ionic surfactant, wherein the non-ionic surfactant may be comprised of alkoxy polyethoxy ethanol, diethanolamine, coconut oil diethanolamide, acrylic polymer, nonylphenol ethoxylate, oleamide DEA, oleic acid, a combination thereof, or others;
about 0% by weight to about 5% by weight of a fragrance;
about 0% by weight to about 5% by weight of a dye; and
a balance selected from the group consisting of water, organic solvent carrier, or a combination thereof, wherein the organic solvent carrier may be comprised of petroleum distillate, Stoddard solvent, synthetic isoparafinic hydrocarbon, petroleum hydrocarbon, aliphatic hydrocarbon, 2,2-dimethylbutane, or a combination thereof.

According to another embodiment of the method, the composition may include:
about 4% by weight to about 20% by weight of an amino functional siloxane;
about 0% by weight to about 5% by weight of a volatile cyclic siloxane;
about 0% by weight to about 15% by weight of a drying agent;
about 1% by weight to about 20% by weight of a non-ionic surfactant;
about 0% by weight to about 5% by weight of a fragrance;
about 0% by weight to about 5% by weight of a dye; and
a balance selected from the group consisting of water, organic solvent carrier, or a combination thereof.

According to yet another embodiment of the method, the composition may include:
about 4.5% by weight to about 8.5% by weight of an amino functional siloxane;
about 0% by weight to about 5% by weight of a volatile cyclic siloxane;
about 1.5% by weight to about 6% by weight of a drying agent;
about 10% by weight to about 15% by weight of a non-ionic surfactant;
about 0% by weight to about 5% by weight of a fragrance;
about 0% by weight to about 5% by weight of a dye; and
a balance selected from the group consisting of water, organic solvent carrier, or a combination thereof.

According to a further embodiment of the method, the composition may include:
about 40% by weight to about 100% by weight of an amino functional siloxane;
about 0% by weight to about 5% by weight of a volatile cyclic siloxane;
about 0% by weight to about 50% by weight of a drying agent;
about 0% by weight of a non-ionic surfactant;
about 0% by weight to about 5% by weight of a fragrance;
about 0% by weight to about 5% by weight of a dye; and
a balance of organic solvent carrier.

According to yet another embodiment of the method, the composition may include:
about 50% by weight to about 85% by weight of an amino functional siloxane;
about 0.5% by weight to about 5% by weight of a volatile cyclic siloxane;
about 9% by weight to about 28% by weight of a drying agent;
about 0% by weight to about 20% by weight of a non-ionic surfactant;
about 0% by weight to about 5% by weight of a fragrance;
about 0% by weight to about 5% by weight of a dye; and
a balance of organic solvent carrier.

According to certain embodiments of the invention, a composition for addition to a finishing product at the time of application of the finishing product to a surface for boosting the performance of a finishing product for application to a surface, wherein the composition may include an amino functional siloxane.

The amino functional siloxane may be comprised of amino-alkoxy dimethylsiloxane, aminoalkoxydimethylpolysiloxane, a combination thereof, or others.

In certain embodiments of the invention, the composition may include from about 4% by weight to about 100% by weight of amino functional siloxane. In other embodiments, the composition may include from about 4% by weight to about 20% by weight of amino functional siloxane. In another embodiment, the composition may include from about 4.5% by weight to about 8.5% by weight of amino functional siloxane. In other embodiments, the composition may include from about 40% by weight to about 100% by weight of amino functional siloxane. In yet another embodiment, the composition may include from about 50% by weight to about 85% by weight of amino functional siloxane.

According to another embodiment of the invention, the composition may further include about 0% by weight to about 20% by weight of a non-ionic surfactant and a balance that may be selected from the group consisting of water, organic solvent carrier, or a combination thereof.

The non-ionic surfactant may be comprised of alkoxy polyethoxy ethanol, diethanolamine, coconut oil diethanolamide, acrylic polymer, nonylphenol ethoxylate, oleamide DEA, oleic acid, a combination thereof, or others.

The organic solvent carrier may be comprised of petroleum distillate, Stoddard solvent, synthetic isoparafinic hydrocarbon, petroleum hydrocarbon, aliphatic hydrocarbon, 2,2-dimethylbutane, a combination thereof, or others.

In certain embodiments, the composition may include about 1% by weight to about 20% by weight of a non-ionic surfactant and a balance selected from the group consisting of water, organic solvent carrier, or a combination thereof. In other embodiments, the composition may include about 10% by weight to about 15% by weight of a non-ionic surfactant and a balance selected from the group consisting of water, organic solvent carrier, or a combination thereof. In further embodiments, the composition includes about 0% by weight of a non-ionic surfactant and a balance of organic solvent carrier.

According to yet another embodiment of the invention, the composition may further include about 0% by weight to about 50% by weight of a drying agent.

The drying agent may be comprised of isopropyl alcohol, methyl alcohol, 1,2,4-trimethylbenzene, a combination thereof, or others.

In certain embodiments, the composition may include about 0% by weight to about 15% by weight of a drying agent. In other embodiments, the composition may include about 1.5% by weight to about 6% by weight of a drying agent. In yet another embodiment, the composition may include about 9% by weight to about 28% by weight of a drying agent.

In further embodiments of the invention, the composition may also include about 0% by weight to about 5% by weight of a volatile cyclic siloxane.

The volatile cyclic siloxane may be comprised of dimethylcyclosiloxane, hexamethylcyclotrisiloxane, octamethylcyclotetrasiloxane, decamethylcyclopentasiloxane, dodecamethylcyclohexasiloxane, a combination thereof, or others.

In certain embodiments, the composition may include about 0.5% by weight to about 5% by weight of a volatile cyclic siloxane.

According to yet another embodiment of the invention, the composition further includes about 0% by weight to about 5% by weight of fragrance, and may include about 0% by weight to about 5% by weight of dye.

According to one embodiment of the invention, the composition may include:
about 4% by weight to about 100% by weight of an amino functional siloxane, wherein the one or more amino functional siloxanes may be comprised of amino-alkoxy dimethylsiloxane, aminoalkoxydimethylpolysiloxane, a combination thereof, or others;
about 0% by weight to about 5% by weight of a volatile cyclic siloxane, wherein the volatile cyclic siloxane may be comprised of dimethylcyclosiloxane, hexamethylcyclotrisiloxane, octamethylcyclotetrasiloxane, decamethylcyclopentasiloxane, dodecamethylcyclohexasiloxane, a combination thereof, or others;
about 0% by weight to about 50% by weight of a drying agent, wherein the drying agent may be comprised of isopropyl alcohol, methyl alcohol, 1,2,4-trimethylbenzene, a combination thereof, or others;
about 0% by weight to about 20% by weight of a non-ionic surfactant, wherein the non-ionic surfactant may be comprised of alkoxy polyethoxy ethanol, diethanolamine, coconut oil diethanolamide, acrylic polymer, nonylphenol ethoxylate, oleamide DEA, oleic acid, a combination thereof, or others;
about 0% by weight to about 5% by weight of a fragrance;
about 0% by weight to about 5% by weight of a dye; and
a balance selected from the group consisting of water, organic solvent carrier, or a combination thereof, wherein the organic solvent carrier may be comprised of petroleum distillate, Stoddard solvent, synthetic isoparafinic hydrocarbon, petroleum hydrocarbon, aliphatic hydrocarbon, 2,2-dimethylbutane, or a combination thereof.

According to another embodiment of the invention, the composition may include:
about 4% by weight to about 20% by weight of an amino functional siloxane;
about 0% by weight to about 5% by weight of a volatile cyclic siloxane;
about 0% by weight to about 15% by weight of a drying agent;
about 1% by weight to about 20% by weight of a non-ionic surfactant;
about 0% by weight to about 5% by weight of a fragrance;
about 0% by weight to about 5% by weight of a dye; and
a balance selected from the group consisting of water, organic solvent carrier, or a combination thereof.

According to yet another embodiment of the invention, the composition may include:
about 4.5% by weight to about 8.5% by weight of an amino functional siloxane;
about 0% by weight to about 5% by weight of a volatile cyclic siloxane;
about 1.5% by weight to about 6% by weight of a drying agent;
about 10% by weight to about 15% by weight of a non-ionic surfactant;
about 0% by weight to about 5% by weight of a fragrance;
about 0% by weight to about 5% by weight of a dye; and
a balance selected from the group consisting of water, organic solvent carrier, or a combination thereof.

According to a further embodiment of the invention, the composition may include:
about 40% by weight to about 100% by weight of an amino functional siloxane;
about 0% by weight to about 5% by weight of a volatile cyclic siloxane;
about 0% by weight to about 50% by weight of a drying agent;
about 0% by weight of a non-ionic surfactant;
about 0% by weight to about 5% by weight of a fragrance;
about 0% by weight to about 5% by weight of a dye; and
a balance of organic solvent carrier.

According to yet another embodiment of the invention, the composition may include:
about 50% by weight to about 85% by weight of an amino functional siloxane;
about 0.5% by weight to about 5% by weight of a volatile cyclic siloxane;
about 9% by weight to about 28% by weight of a drying agent;
about 0% by weight to about 20% by weight of a non-ionic surfactant;
about 0% by weight to about 5% by weight of a fragrance;
about 0% by weight to about 5% by weight of a dye; and
a balance of organic solvent carrier.

In the examples below, several embodiments of the invention are described. However, these examples are not intended to limit the scope of the invention.

### EXAMPLES

### Example One

A non-aqueous finishing product booster additive may be prepared by combining the following:
about 20% by weight to about 35% by weight of amino-alkoxy dimethylsiloxane;
about 30% by weight to about 48% by weight of aminoalkoxy dimethylpolysiloxane;
about 0.5% by weight to about 2.5% by weight of decamethylcyclopentasiloxane;
about less than 17.5% by weight of petroleum distillate;
about less than 17% by weight of Stoddard solvent;
about 7.5% by weight to about 20% by weight of isopropyl alcohol;
about 0.5% by weight to about 2.5% by weight of 1,2,4-trimethylbenzene;
about 2.5% by weight to about 4.5% by weight of methyl alcohol;
about less than 5% by weight of green dye; and
about less than 5% by weight of fragrance.

### Example Two

A non-aqueous finishing product booster additive may be prepared by combining the following:
about 5 gallons of Dow Corning® 531 Fluid, from Dow Corning Corporation, of Midland Mich.;
about 5 gallons of Dow Corning® 536 Fluid, from Dow Corning Corporation, of Midland Mich.;
about 50 grams of green dye; and
about 5 ounces of fragrance.

### Example Three

An aqueous finishing product booster additive may be prepared by combining the following:
about 4.8% by weight to about 8.4% by weight of amino-alkoxy dimethylsiloxane;
about less than 4.2% by weight of petroleum distillate;
about less than 4.1% by weight of Stoddard solvent;
about 1.8% by weight to about 4.8% by weight of isopropyl alcohol;
about 1.2% by weight to about 6% by weight of 1,2,4-trimethylbenzene;
about less than 1.2% by weight of methyl alcohol;
about 12% by weight nonylphenol ethoxylate;
about less than 76% by weight water;
about less than 5% by weight of green dye; and
about less than 5% by weight of fragrance.

The ingredients may be blended into an emulsion with an industrial homogenizer, such as the UIP2000 from Hielscher—Ultrasound Technology, Ringwood N.J.

### Example Four

An aqueous finishing product booster additive may be prepared by combining the following:
about 12% by weight of Dow Corning® 531 Fluid, from Dow Corning Corporation, of Midland Mich.;
about 12% by weight of nonylphenol ethoxylate;
about less than 5% by weight of green dye;
about less than 5% by weight fragrance; and
about less than 76% by weight water.

The ingredients may be blended into an emulsion with an industrial homogenizer, such as the UIP2000 from Hielscher—Ultrasound Technology, of Ringwood N.J.

### Example Five

An aqueous finishing product booster additive may be prepared by combining the following:
about 10 gallons T-GUARD 450 from Taylor Chemical Company, Lawrenceville, Ga., or TEGO® Polish Additiv AE 30, from Degussa, supplied by Goldschmidt Chemical Corporation, Hopewell, Va.;
about less than 5% by weight of green dye; and
about less than 5% by weight fragrance.

The ingredients may be blended into an emulsion with an industrial homogenizer, such as the UIP2000 from Hielscher—Ultrasound Technology, Ringwood N.J.

### Example Six

A finishing product may be boosted by the addition of the non-aqueous finishing product booster additive of Example One or Example Two as follows:

| Non-Aqueous | |
|---|---|
| Finishing Product | |
| Booster Additive of | |
| Example One or | |
| Example Two | Finishing Product |
| 1.5 g | 1 fluid ounce Super Resin Polish from Autoglym |
| 1.5 g | 1 fluid ounce Ultra Deep Shine from Autoglym |
| 1.5 g | 1 fluid ounce Blackfire All Finish Paint Protection |
| | from Classic Motoring Accessories |
| 1.5 g | 1 fluid ounce Insulator Wax by Collinite |
| 1.5 g | 1 fluid ounce Detailer's Pride Premium Surface |
| | Shield Paint Sealant from Palm Beach Motoring |
| | Accessories |
| 1.5 g | 1 fluid ounce Clear Coat Polish from Duragloss |
| 1.5 g | 1 fluid ounce Total Performance Polish from |
| | Duragloss |
| 1.5 g | 1 fluid ounce Ultimate Paint Protection from Four |
| | Star Products. |
| 1.5 g | 1 fluid ounce Liquid Glass from Liquid Glass |
| 1.5 g | 1 fluid ounce #20 Professional Sealant from |
| | Meguiar's |
| 1.5 g | 1 fluid ounce #21 Professional Sealant from |
| | Meguiar's |
| 1.5 g | 1 fluid ounce NXT Generation Tech Wax from |
| | Meguiar's |
| 1.5 g | 1 fluid ounce #26 Hi-Tech Yellow Wax from |
| | Meguiar's |
| 1.5 g | 1 fluid ounce Color X from Meguiar's |
| 1.5 g | 1 fluid ounce Gold Class Car Wax Liquid from |
| | Meguiar's |
| 1.5 g | 1 fluid ounce Menzerna FMJ (Full Molecular |
| | Jacket) from Classic Motoring Accessories. |
| 1.5 g | 1 fluid ounce Menzerna One Step Acrylic Jacket |
| | from Classic Motoring Accessories. |
| 1.5 g | 1 fluid ounce Pure Carnuaba Wax (liquid) from |
| | Mothers |
| 1.5 g | 1 fluid ounce Sealer and Glaze from Mothers |
| 1.5 g | 1 fluid ounce FX SynWax from Mothers |
| 1.5 g | 1 fluid ounce Reflections Advanced Car Wax from |
| | Mothers |
| 1.5 g | 1 fluid ounce Reflections Top Coat from Mothers |
| 1.5 g | 1 fluid ounce Car Wax from Optimum |
| 1.5 g | 1 fluid ounce Poli-Seal from Optimum |
| 1.5 g | 1 fluid ounce Pinnacle Liquid Souveran from Palm |
| | Beach Motoring Acessories |
| 1.5 g | 1 fluid ounce EX-P from Poorboys |
| 1.5 g | 1 fluid ounce EX from Poorboys |
| 1.5 g | 1 fluid ounce Quick Wax from Poorboys |
| 1.5 g | 1 fluid ounce SmartWax from Chemical Guys |
| 1.5 g | 1 fluid ounce SmartSealant from Chemical Guys |
| 1.5 g | 1 fluid ounce Paint Sealant from TurboWax |
| 1.5 g | 1 fluid ounce Ultra Gloss Liquid Wax from Turtle |
| | Wax |
| 1.5 g | 1 fluid ounce Wolfgang Deep Gloss Paint Sealant |
| | from Palm Beach Motoring Accessories |
| 1.5 g | 1 fluid ounce Wolfgang Plastik Surface Sealant |
| | from Palm Beach Motoring Accessories |
| 1.5 g | 1 fluid ounce Z2 from Zaino Brothers |
| 1.5 g | 1 fluid ounce Z3 from Zaino Brothers |
| 1.5 g | 1 fluid ounce Z5 from Zaino Brothers |

The non-aqueous finishing product booster additive should be well mixed before adding to the finishing product. After addition the finishing product containing the non-aqueous finishing product booster should be well mixed and should be applied to a surface within 48 hours. The finishing product containing the non-aqueous finishing product booster additive should be stored in a closed container and should be discarded after 48 hours.

### Example Seven

A finishing product may be boosted by the addition of the aqueous finishing booster additive of Example Three, Example Four, or Example Five as follows:

| Aqueous Finishing | |
|---|---|
| Product Booster | |
| Additive of | |
| Examples Three, | |
| Four, or Five | Finishing Product |
| 0.75 g | 4 fluid ounce Blackfire Deep Gloss Spray Sealant |
| | from Classic Motoring Accessories |
| 0.75 g | 4 fluid ounce Sapphire Wax from Collinite |
| 0.75 g | 4 fluid ounce Detailer's Pride Final Gloss Booster |
| | Spray Wax from Palm Beach Motoring |
| | Accessories |
| 0.75 g | 4 fluid ounce Detailer's Pride Spray Surface Shield |
| | Paint Sealant from Palm Beach Motoring |
| | Accessories |
| 0.75 g | 4 fluid ounce Detailer's Pride Final Gloss Quick |
| | Detailer from Palm Beach Motoring Accessories |
| 0.75 g | 4 fluid ounce Wet Wipe N′ Shine from Eagle 1 |
| 0.75 g | 4 fluid ounce Einmann Fabrik Clear Pearl II Instant |
| | Detail Spray from Classic Motoring Accessories |
| 0.75 g | 4 fluid ounce Waxx speed wax from Flitz |
| 0.75 g | 4 fluid ounce Ultimate Paint Protection Spray from |
| | Four Star Products |
| 0.75 g | 4 fluid ounce Ultimate Gloss Enhancer Detail Spray |
| | from Four Star Products |
| 1.5 g | 1 fluid ounce Acrylic Jett from Jeff's Werkstatt |
| 1.5 g | 1 fluid ounce Prime from Jeff's Werkstatt |
| 1.5 g | 1 fluid ounce All-In-One from Klasse |
| 1.5 g | 1 fluid ounce Sealant Glaze from Klasse |
| 0.75 g | 4 fluid ounce Quik Detailer from Meguiar's |
| 0.75 g | 4 fluid ounce Final Inspection from Meguiar's |
| 0.75 g | 4 fluid ounce NXT Generation Speed Detailer from |
| | Meguiar's |
| 0.75 g | 4 fluid ounce Menzerna High Gloss Acrylic Shield |
| | from Classic Motoring Accessories |
| 0.75 g | 4 fluid ounce Showtime Detail Spray from Mothers |
| 0.75 g | 4 fluid ounce NTS7 Liquid Shield from Sonax |
| 0.75 g | 4 fluid ounce NTS7 Express Shine from Sonax |
| 0.75 g | 4 fluid ounce Pinnacle Crystal Mist Detail Spray |
| | from Palm Beach Motoring Accessories |
| 0.75 g | 4 fluid ounce Pinnacle Souveran Liquid Spray Wax |
| | from Palm Beach Motoring Accessories |
| 0.75 g | 4 fluid ounce SmartDetail from Chemical Guys |
| 0.75 g | 4 fluid ounce Sonus Acrylic Spritz from The Perfect |
| | Shine |
| 0.75 g | 4 fluid ounce Sonus Acrylic Glanz from The Perfect |
| | Shine |
| 0.75 g | 4 fluid ounce Sonus Carnauba Spritz from The |
| | Perfect Shine |
| 0.75 g | 4 fluid ounce Last Minute Detailer from TurboWax |
| 0.75 g | 4 fluid ounce Wolfgang Deep Gloss Spritz Sealant |
| | from Palm Beach Motoring Accessories |
| 1.5 g | 4 fluid ounce Z6 from Zaino Brothers |

The aqueous finishing product booster additive should be well mixed before adding to the finishing product.

While particular embodiments of the present invention have been disclosed, it is to be understood that various different modifications are possible and are contemplated within the true spirit and scope of the appended claims.

What is claimed is:

1. A method for boosting the performance of a finishing product for application to a surface, comprising: adding to the finishing product at the time of application, a composition including an amino functional siloxane.

2. The method of claim 1, wherein the amino functional siloxane is comprised of amino-alkoxy dimethylsiloxane, aminoalkoxydimethylpolysiloxane, or a combination thereof.

3. The method of claim 1, wherein the composition includes from about 4% by weight to about 100% by weight of an amino functional siloxane.

4. The method of claim 1, wherein the composition further includes about 0% by weight to about 20% by weight of a non-ionic surfactant and a balance selected from the group consisting of water, organic solvent carrier, or a combination thereof.

5. The method of claim 4, wherein the non-ionic surfactant is comprised of alkoxy polyethoxy ethanol, diethanolamine, coconut oil diethanolamide, acrylic polymer, nonylphenol ethoxylate, oleamide DEA, oleic acid, or a combination thereof.

6. The method of claim 4, wherein the organic solvent carrier is comprised of petroleum distillate, Stoddard solvent, synthetic isoparafinic hydrocarbon, petroleum hydrocarbon, aliphatic hydrocarbon, 2,2-dimethylbutane, or a combination thereof.

7. The method of claim 1, wherein the composition further includes about 0% by weight to about 50% by weight of a drying agent.

8. The method of claim 7, wherein the drying agent is comprised of isopropyl alcohol, methyl alcohol, 1,2,4-trimethylbenzene, or a combination thereof.

9. The method of claim 1, wherein the composition further includes about 0% by weight to about 5% by weight of a volatile cyclic siloxane.

10. The method of claim 9, wherein the volatile cyclic siloxane is comprised of dimethylcyclosiloxane, hexamethylcyclotrisiloxane, octamethylcyclotetrasiloxane, decamethylcyclopentasiloxane, dodecamethylcyclohexasiloxane, or a combination thereof.

11. The method of claim 1, wherein the composition includes:
about 4% by weight to about 100% by weight of an amino functional siloxane, wherein the amino functional siloxane is comprised of amino-alkoxy dimethylsiloxane, aminoalkoxydimethylpolysiloxane, or a combination thereof;
about 0% by weight to about 5% by weight of a volatile cyclic siloxane, wherein the volatile cyclic siloxane is comprised of dimethylcyclosiloxane, hexamethylcyclotrisiloxane, octamethylcyclotetrasiloxane, decamethylcyclopentasiloxane, dodecamethylcyclohexasiloxane, or a combination thereof;
about 0% by weight to about 50% by weight of a drying agent, wherein the drying agent is comprised of isopropyl alcohol, methyl alcohol, 1,2,4-trimethylbenzene, or a combination thereof;
about 0% by weight to about 20% by weight of a non-ionic surfactant, wherein the non-ionic surfactant is comprised of alkoxy polyethoxy ethanol, diethanolamine, coconut oil diethanolamide, acrylic polymer, nonylphenol ethoxylate, oleamide DEA, oleic acid, or a combination thereof;
about 0% by weight to about 5% by weight of a fragrance;
about 0% by weight to about 5% by weight of a dye; and
a balance selected from the group consisting of water, organic solvent carrier, or a combination thereof, wherein the organic solvent carrier is comprised of petroleum distillate, Stoddard solvent, synthetic isoparafinic hydrocarbon, petroleum hydrocarbon, aliphatic hydrocarbon, 2,2-dimethylbutane, or a combination thereof.

12. A composition for addition to a finishing product at the time of application of the finishing product to a surface for boosting the performance of a finishing product for application to a surface, wherein the composition includes an amino functional siloxane.

13. The composition of claim 12, wherein the amino functional siloxane is comprised of amino-alkoxy dimethylsiloxane, aminoalkoxydimethylpolysiloxane, or a combination thereof.

14. The composition of claim 12, wherein the composition includes from about 4% by weight to about 100% by weight of an amino functional siloxane.

15. The composition of claim 12, wherein the composition further includes about 0% by weight to about 20% by weight of a non-ionic surfactant and a balance selected from the group consisting of water, organic solvent carrier, or a combination thereof.

16. The composition of claim 15, wherein the non-ionic surfactant is comprised of alkoxy polyethoxy ethanol, diethanolamine, coconut oil diethanolamide, acrylic polymer, nonylphenol ethoxylate, oleamide DEA, oleic acid, or a combination thereof.

17. The composition of claim 15, wherein the organic solvent carrier is comprised of petroleum distillate, Stoddard solvent, synthetic isoparafinic hydrocarbon, petroleum hydrocarbon, aliphatic hydrocarbon, 2,2-dimethylbutane, or a combination thereof.

18. The composition of claim 12, wherein the composition further includes about 0% by weight to about 50% by weight of a drying agent.

19. The composition of claim 18, wherein the drying agent is comprised of isopropyl alcohol, methyl alcohol, 1,2,4-trimethylbenzene, or a combination thereof.

20. The composition of claim 12, wherein the composition further includes about 0% by weight to about 5% by weight of a volatile cyclic siloxane.

21. The composition of claim 20, wherein the volatile cyclic siloxane is comprised of dimethylcyclosiloxane, hexamethylcyclotrisiloxane, octamethylcyclotetrasiloxane, decamethylcyclopentasiloxane, dodecamethylcyclohexasiloxane, or a combination thereof.

22. The composition of claim 12, wherein the composition includes:
about 4% by weight to about 100% by weight of an amino functional siloxane, wherein the amino functional siloxanes is comprised of amino-alkoxy dimethylsiloxane, aminoalkoxydimethylpolysiloxane, or a combination thereof;
about 0% by weight to about 5% by weight of a volatile cyclic siloxane, wherein the volatile cyclic siloxane is comprised of dimethylcyclosiloxane, hexamethylcyclotrisiloxane, octamethylcyclotetrasiloxane, decamethylcyclopentasiloxane, dodecamethylcyclohexasiloxane, or a combination thereof;
about 0% by weight to about 50% by weight of a drying agent, wherein the drying agent is comprised of isopropyl alcohol, methyl alcohol, 1,2,4-trimethylbenzene, or a combination thereof;
about 0% by weight to about 20% by weight of a non-ionic surfactant, wherein the non-ionic surfactant is comprised of alkoxy polyethoxy ethanol, diethanolamine, coconut oil diethanolamide, acrylic polymer, nonylphenol ethoxylate, oleamide DEA, oleic acid, or a combination thereof;
about 0% by weight to about 5% by weight of a fragrance;
about 0% by weight to about 5% by weight of a dye; and
a balance selected from the group consisting of water, organic solvent carrier, or a combination thereof, wherein the organic solvent carrier is comprised of petroleum distillate, Stoddard solvent, synthetic isoparafinic hydrocarbon, petroleum hydrocarbon, aliphatic hydrocarbon, 2,2-dimethylbutane, or a combination thereof.
